(19) United States
(12) Patent Application Publication
(10) Pub. No.: US 2024/0269806 A1
(43) Pub. Date: Aug. 15, 2024

(54) Safe Tool for an Individual Pumping Unit

(71) Applicant: Del Plata Ingeniería SA, Mar del Plata (AR)

(72) Inventor: Santiago Miguel Cerviño, Mar del Plata (AR)

(73) Assignee: Del Plata Ingeniería SA, Mar del Plata (AR)

(21) Appl. No.: 18/440,592

(22) Filed: Feb. 13, 2024

Related U.S. Application Data
(60) Provisional application No. 63/484,657, filed on Feb. 13, 2023.

(51) Int. Cl. B25B 21/00; B25B 21/02; F15B 1/04; F15B 13/02

(52) U.S. Cl. CPC B25B 21/002; B25B 21/02; F15B 1/04; F15B 13/027

(57) ABSTRACT

A system for carrying out the stroke change of an individual pumping unit (IPU) comprising a hydraulic-mechanical wrench, a pneumatic striker, and a power source. The hydraulic-mechanical wrench includes a fixed fastening anchor to a double-acting hydraulic cylinder, a toothed wheel with a center recess for a nut wrench, and a pull chain. The pneumatic striker comprises a body housing a displaceable striking piston with a spring located between the back cover of the body and the piston, a normally open check valve, and a firing valve integrated into the body. The check valve is pneumatically piloted, taking pressure through a hose from the power source. The power source comprises an air compressor and a hydraulic pump connected to an incrementing tank, within which a piston separates the pneumatic circuit from the hydraulic one. It also includes an electrical/electronic circuit with a Programmable Logic Controller (PLC) that controls sequences and pressures, governs switches and buttons, and activates power relays of the equipment from a control panel. A procedure for carrying out the stroke change of an individual pumping unit (IPU) with the described equipment is also provided.

### REFERENCE TO RELATED APPLICATIONS

This application claims priority to U.S. Provisional Patent Appl. No. 63/484,657 and incorporates that application in its entirety.

### FIELD OF THE INVENTION

The STAIB tools (Safe Tool for AIB) are used to safely and efficiently carry out the stroke change of individual pumping units (IPU). The stroke change of the IPU aims to modify the travel of the rod string and, consequently, the piston of the downhole pump. It is performed by extracting the conical pin that articulates the crank-rod mechanism and placing it in another position. To remove the conical pin from its housing, the nut that secures it must first be removed. Then, the pin is unclamped, placed in the new position, and finally, the nut is tightened.

### BACKGROUND OF THE INVENTION

The stroke change is typically carried out using a striking wrench to loosen and subsequently tighten the nut. The pin is unclamped using a hammer.

The procedure involves working in a forced position, at heights, and with forceful gestures. There is a risk of losing balance and an increased possibility of falls from different levels.

Regarding striking tools, due to their nature, they may have fitting failures between the handle and the tool, resulting in detachment and potential impacts on various parts of the operator's or others' bodies.

The maneuver in general involves physical effort in unsafe conditions, increasing the operator's fatigue and exposing them to injuries.

The use of STAIB tools improves the ergonomic risk factors of the task. Physical efforts are reduced, and violent gestures at heights are eliminated, decreasing the possibility of accidents. Additionally, there is an improvement in the total time spent on the stroke change, enhancing performance, and reducing operator fatigue.

Knowledge is available regarding the publication of the patent application US2019/0217458A1, granted as U.S. Ser. No. 10/124,477B2. In this publication, the tool allows for the unfastening of the bolt, with the possibility of remote control. The tool has a length of 25″ and operates with an air pressure between 100 psi and 150 psi.

The improvements proposed by STAIB allow performing the tasks of releasing the nut with the hydromechanical wrench as well as unbolting the bolt with the pneumatic striker, which is approximately 13 inches in length, within a single integrated tool. Due to its dimensions of approximately 13 inches, the striker can be placed in a narrow space, thus enabling the option of performing the operation from ground level with the crank and its housings in a lower position. Additionally, this equipment has its own pneumatic and hydraulic unit.

### BRIEF STATEMENT OF THE INVENTION

The object of the present invention is to provide an integral tool to facilitate the stroke change of an individual pumping unit (IPU). The tasks to be performed are:

Loosening and adjusting anchor nuts for bolts.

Unbolting bolts.

Therefore, the object of the present invention is a system for carrying out the stroke change of an individual pumping unit (IPU) that comprises a hydromechanical wrench, a pneumatic striker, and a power source, wherein:

the hydromechanical wrench comprises a fastening anchor attached to a double-acting hydraulic cylinder, a toothed wheel with a center recess for nut wrench, and a pull chain;

the pneumatic striker comprises a body, a movable striking piston mounted inside with a spring located between the rear cover of the body and the piston, a normally open check valve, and a trigger valve integrated into the body, wherein the check valve is pneumatically controlled by taking pressure through a hose from the power source; and

the power source comprises a compressor and a hydraulic pump connected to an accumulator tank within which a piston separates the pneumatic circuit from the hydraulic circuit, and an electrical/electronic circuit comprising a PLC (Programmable Logic Controller) that controls sequences and pressures, governs switches and push buttons, and actuates power relays of the equipment from a control panel.

In particular, the hydromechanical key comprises a fixing anchor as a fixed point of pull. Attached to the anchor, there is a double-acting hydraulic cylinder as a force element, a toothed wheel has a socket for a wrench in the center, and a pull chain, which, in use, engages with the toothed wheel to generate a torque for loosening a nut when pulled by the hydraulic cylinder.

Also, particularly, the pneumatic striker comprises a body, a striking piston or plunger movably mounted inside it with a spring located between the back cap of the body and the plunger. It includes a normally open check valve and a firing valve integrated into the body. In use, the body of the pneumatic striker is attached to a bolt of an IPU using an adapter nut that is removable, allowing adjustment to different types of bolts. The adapter nut has perforations that allow air to escape, preventing damping of the impact. The body includes the integrated quick firing valve, which, in use, enables remote firing of the plunger from a safe zone. The plunger returns automatically through the spring and the normally open check valve, allowing the evacuation of accumulated air within the striker cylinder. While the cylinder is pressurized, the valve prevents air escape. The firing valve is pneumatically piloted, taking pressure through a hose from the power source.

Especially, the power source comprises an air compressor and a hydraulic pump connected to an accumulator tank. Within the tank, there is a piston that separates the pneumatic circuit from the hydraulic circuit. There is also an electrical/electronic circuit that includes a Programmable Logic Controller (PLC) responsible for controlling sequences and pressures. The PLC governs switches and buttons on a control panel and activates power relays for the equipment. In use, the compressor supplies pressurized air at approximately 7 bar to the tank, which acts as an accumulator for the necessary air volume for each application. The hydraulic pump increases the air pressure to approximately 21 bar by transferring hydraulic pressure to the pneumatic circuit through the piston.

In a preferred embodiment, the toothed wheel is manufactured from a lightweight material, preferably an aluminum alloy, more preferably aluminum 7075.

Also preferably, the socket in the center of the toothed wheel is made of a heavy material, preferably a steel alloy.

Preferably, a safety feature on the toothed wheel prevents the chain from detaching.

Additionally, preferably, the striking piston is actuated with compressed air through a hose connected to the power source.

Even more preferably, the pressure increases between 300 psi and 350 psi to propel the striking piston against the bolt.

Still preferably, the final dimensions of the striker are approximately 327 mm in length with a larger diameter of about 194 mm, making it compact for operation in confined spaces.

Specifically, the PLC controls sequences and pressures by reading the state of switches and buttons and activates the power relays of the hydraulic pump and the air compressor.

Essentially, the external power supply is a battery from a truck or vehicle with the engine running.

Another object of the present invention is a method for changing the stroke of an individual pumping unit (IPU) with the described equipment, comprising the steps of:
1) extract the first nut from the crank of an individual pumping unit (IPU) using the hydromechanical key and loosen a second nut on the opposite side with the same hydromechanical key installed on the opposite side; and
2) unbolt a first bolt by screwing the locknut onto the bolt to be unfastened, placing the threaded cap on the bolt, screwing the adapter disk, and aligning the pneumatic striker cylinder correctly; then repeat the maneuver to unbolt the second bolt.

Specifically, the extraction of the nuts involves the following sub-steps:
a) position the crank of an individual pumping unit (IPU) so that the pneumatic striker can be placed;
b) remove the key lock from the nut;
c) place the toothed wheel, ensuring that the interchangeable center of the toothed wheel is the correct one;
d) place a cover under the tool working area to prevent the chain from getting dirty;
e) hook the hydraulic cylinder onto the double “T” profile at the front of the IPU chassis for using the hydromechanical key;
f) connect the two oil hoses from the power source to the hydraulic cylinder;
g) verify that the electrical power supply installation is correct;
h) check the oil level by observing the level on the left side of the power source;
i) set the “Operation Selector” valve located on the control panel of the power source to the “Hydromechanical Key” position;
j) power the hydraulic pump by turning the “Hydraulic Power Plant” key to the “ON” position;
k) press the “OUT” button until the entire hydraulic cylinder rod is fully extended;
l) place the chain over the toothed wheel in a way that it wraps at least half a turn around the wheel, considering the direction of rotation and ensuring it is under tension;
m) secure the chain to the toothed wheel with the safety at the free end of the chain or its last link;
n) clear the work area, positioning oneself behind the person operating the STAIB equipment while it is in operation;
ñ) press the “IN” button until the nut loosens, and de-energize the hydraulic pump by turning the “Hydraulic Power Plant” key to the “OFF” position;
o) remove the chain safety, take it off the toothed wheel, place the chain on the protective cover, and extract the nut;
p) loosen the second nut on the other side by repeating all the steps of this operation except steps a), g), h), and i);
q) retract the rod until it is fully inside by pressing the “IN” button on the power source control panel before disconnecting the hoses from the hydraulic cylinder; and
r) install the appropriate protectors for the cylinder and hoses.

Fundamentally, in step 1.p), the direction of rotation must be considered when placing the chain on the toothed wheel.

Specifically, the unbolting and extraction of the bolts involve the following sub-steps:
a) clean the threads of the bolts thoroughly with a steel brush;
b) screw the locknut onto the bolt to be unfastened;
c) place the threaded cap on the bolt, where the threaded cap remains freely
supported on it;
d) screw the adapter disk until it makes contact with the recess of the bolt, and the tip of the bolt protrudes from the front of the nut;
e) support the pneumatic striker cylinder so that the nut's recess fits into it to achieve proper alignment;
f) screw on the cap and tighten it against the pneumatic striker cylinder using an appropriate wrench;
g) tighten the locknut against the nut of the pneumatic striker, ensuring that the cylinder is firmly fixed to the bolt to be unfastened;
h) verify the position of the firing valve before the final adjustment of the striker;
i) connect the end of the 1¼″ hose to the quick-firing valve located on the pneumatic striker using an appropriate wrench;
j) connect the ¼″ hose to the firing valve using the quick coupler;
k) set the “Operation Selector” valve located on the power source control panel to “Pneumatic Striker”;
L) ensure that the vehicle providing the driving force is accelerated to a minimum of approximately 1,500 rpm and that the electrical connections are secure;
m) power the air compressor by turning the “Pneumatic Power Plant” key to the “ON” position;
n) start the compression process by turning the “Pneumatic Power Plant” key to the “Start” position, where this same key will automatically return to the “ON” position where it should remain;
ñ) check for leaks or losses after a few moments of starting the compression process;
o) increase the air pressure with the power source until it reaches approximately 21 kg/cm2 and turn off the “Pneumatic Power Plant” key;
p) clear the work area, positioning oneself behind the person operating the STAIB equipment while it is in operation;
q) unbolt the bolt by quickly opening the “Firing Valve” located at the front of the power source, moving it to the “ON” position. Once the shot is fired, the valve should be returned to the “OFF” position;
   r) depressurize the pneumatic line once the bolt is unfastened by pressing the “Depressurize” button located on the power source control panel, and hold the button until the pressure indicated on the “Pneumatic” pressure gauge stops decreasing;
s) slowly move the firing valve to the “ON” position and leave it open, wait until the pressure indicated on the “Pneumatic” pressure gauge reads “zero” (0), and return the firing valve key to the “OFF” position;
t) unscrew the 1¼″ hose from the pneumatic striker valve;
u) disconnect the ¼″ hose from the pneumatic striker valve;
v) unscrew the cap of the pneumatic striker cylinder and disassemble the cylinder; and
w) repeat all the previously indicated steps from 2.b) to unfasten the other bolt.

In a special manner, in step 2.h), if it is necessary to align the pneumatic striker, rotate it by loosening the cap, adjusting the striker, and then tightening it again.

Also, in a special manner, in step 2.n), the pneumatic pressure automatically rises to approximately 21 kg/cm2, ensuring that the pressure on the “Hydraulic” pressure gauge never exceeds about 23 kg/cm2 for this operation.

Fundamentally, in step 2.ñ), if there are leaks or losses, the system should be depressurized by pressing the “Depressurize” button and slowly opening the firing valve until total depressurization of the system is confirmed. After fixing the leak or loss, restart the process from sub-step 2.e).

Also fundamentally, in step 2.q), if the bolt was not unfastened with the first shot, perform a new shot by repeating the previous step if the pressure is higher than approximately 9 kg/cm2 according to the air pressure gauge, or from step 2.n) of pressurization if the pressure is lower than approximately 9 kg/cm2, as many times as necessary.

Still, in a special manner, in step 2.q), to recompress in the middle of a bolt unfastening operation if the bolt did not unfasten with the first shot and the air pressure indicated on the pressure gauge is lower than approximately 9 kg/cm2, the pneumatic pressure should be brought down below approximately 3 kg/cm2 for the air compressor to start, following these steps:
i) hold down the “Depressurize” button located on the power source control panel until the “Pneumatic” pressure gauge indicates a pressure below approximately 3 kg/cm2; and
ii) if unable to lower the pressure enough, VERY SLOWLY move the firing valve to “ON” to open the pneumatic striker firing valve located at the front of the power source;
iii) once the pressure is below approximately 3 kg/cm2, return the firing valve of the pneumatic striker to the “OFF” position.
iv) next, turn the “Hydraulic Power Plant” key on the power source control panel to the “Start” position so that the system automatically increases the pneumatic pressure to approximately 21 kg/cm2; and
v) to continue with the unfastening of the bolt, resume from step 1.o)

### BRIEF DESCRIPTION OF THE FIGURES

FIG. 1 shows two exploded views of a preferred embodiment of the power source according to the present invention, identifying each component.

FIG. 2 presents a perspective of a preferred embodiment of the hydraulic key according to the present invention.

FIG. 3 offers a perspective of a preferred embodiment of the elements composing the pneumatic striker according to the present invention.

FIG. 4 displays a perspective of a preferred embodiment of the adapters for the pneumatic striker and the nut according to the present invention.

FIG. 5 illustrates the positioning of the crank to allow the placement of the pneumatic striker.

FIG. 6 demonstrates how to remove the key's cotter pin.

FIG. 7 depicts the placement of the toothed wheel.

FIG. 8 showcases the placement of a cover beneath the tool's working area to prevent the chain from getting dirty.

FIG. 9 exhibits the attachment of the hydraulic cylinder to the double “T” profile at the front of the AIB chassis for using the hydromechanical key.

FIG. 10 displays the connection of the two oil hoses from the power source to the hydraulic cylinder.

FIG. 11 shows the “Hydraulic Power Plant” key in the “ON” position on the control panel to energize the hydraulic pump.

FIG. 12 displays the chain on the toothed wheel, positioned to embrace at least half a turn of said wheel.

FIG. 13 illustrates the free end of the chain, or its last link secured to the wheel with the lock.

FIG. 14 demonstrates the “IN” button on the control panel, which must be pressed until the nut loosens.

FIG. 15 exhibits the removal of the chain lock and the withdrawal of the toothed wheel.

FIG. 16 portrays the extraction of the nut.

FIG. 17 shows the placement of the chain on the toothed wheel, considering the direction of rotation to loosen the nut on the other side.

FIG. 18 depicts the screwing of the locknut onto the bolt to be unfastened.

FIG. 19 illustrates the placement of the threaded cap on the bolt.

FIG. 20 displays the screwing of the adapter disk until it reaches the recess of the bolt.

FIG. 21 shows the positioning of the pneumatic striker cylinder so that the recess of the nut fits into it, ensuring correct alignment.

FIG. 22 shows the screwing of the threaded cap, tightening it against the pneumatic striker cylinder using the appropriate wrench.

FIG. 23 shows the locknut tightened against the pneumatic striker nut, so that the cylinder is firmly fixed on the bolt to be unfastened.

FIG. 24 shows a perspective view of the pneumatic striker from FIG. 3, assembled.

FIG. 25 shows the “Operation Selector” valve located on the control panel of the power source set to “Pneumatic Striker,” and the “Pneumatic Power Plant” switch in the “ON” position, energizing the air compressor.

FIG. 26 shows the “Firing Valve” located at the front of the power source, which opens rapidly to unfasten the bolt by moving to the “ON” position, and once the shot is done, the valve must return to the “OFF” position.

FIG. 27 shows the “Depressurize” button located on the control panel of the power source, which must be pressed to depressurize the pneumatic line once the bolt is unfastened, and it must be held down until the pressure indicated on the “Pneumatic” pressure gauge stops dropping.

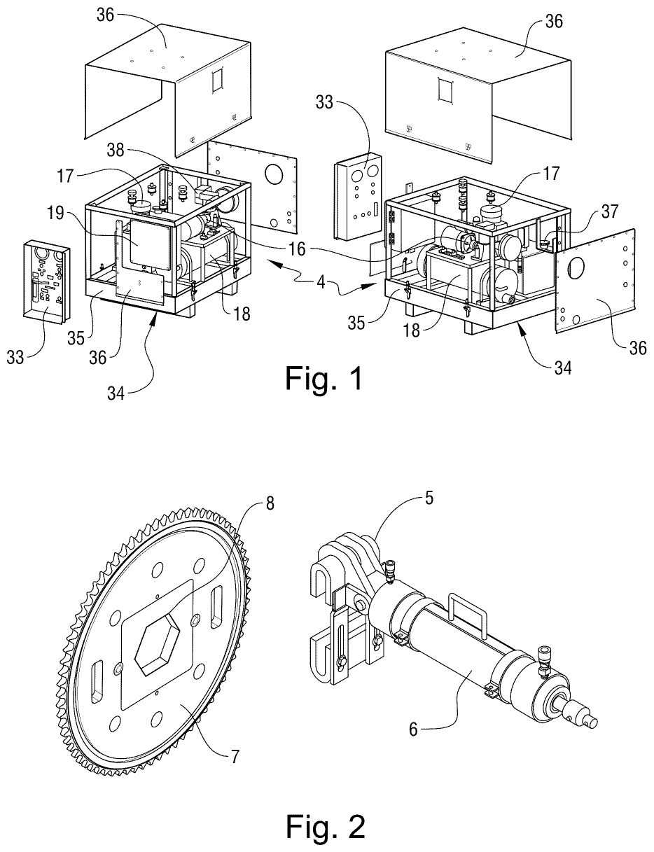

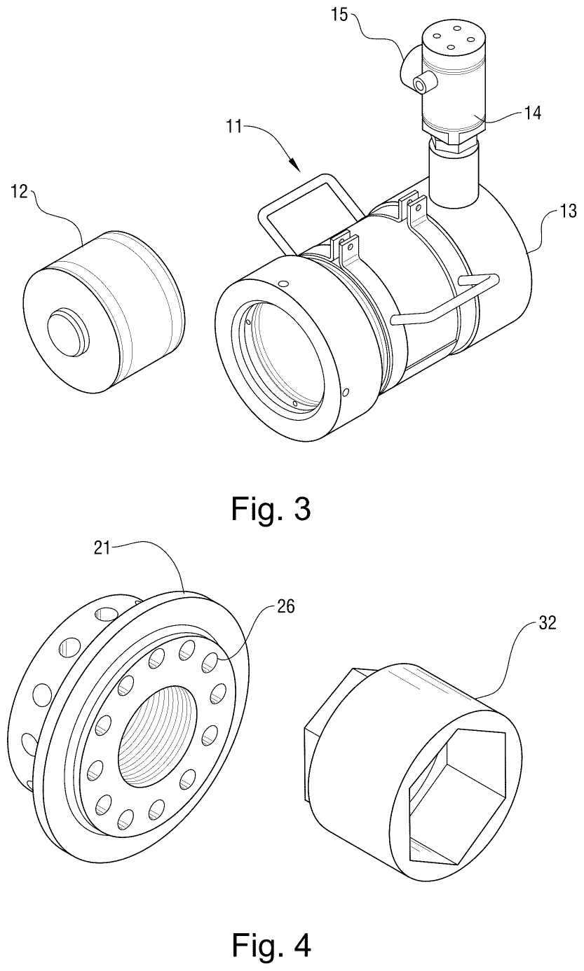

### DETAILED DESCRIPTION OF THE INVENTION

The object of the present invention is an apparatus for changing the stroke of an individual pumping unit (IPU) (1) comprising a hydromechanical key (2), a pneumatic striking cylinder or pneumatic striker (3), and a power source (4).

In particular, the equipment of the present invention comprises:
a hydromechanical key (2) that comprises a securing anchor (5) connected to a double-acting hydraulic cylinder (6); a toothed wheel (7) with a central socket (8) for a nut wrench (9) and a pulling chain.
a pneumatic striker (3) that comprises a body (11) housing a movable striking piston (12) with a spring (not shown) located between the rear cover (13) of the body and the piston, a normally open check valve (14) and a firing valve (15) integrated into the body (11) wherein the check valve (14) is pneumatically piloted, receiving pressure through a hose (not shown) from the power source (4), and
a power source (4) that comprises a compressor (16) and a hydraulic pump (17) connected to an accumulator tank (18) wherein a piston (not shown) separates the pneumatic circuit from the hydraulic circuit, and an electrical/electronic circuit (19) that incorporates a PLC (Programmable Logic Controller) that controls sequences and pressures, governs switches and buttons, and activates power relays on the control panel (26).

The hydromechanical key (2) is composed of a securing anchor (5), a hydraulic cylinder (6), a pulling chain (10), and a toothed wheel (7) with interlocking accessories.

Anchor (5) is secured to the structure (25) of the Individual Pumping Unit (IPU) (1) to provide a fixed point for pulling. Connected to the anchor (5), there is a double-acting hydraulic cylinder (6) used as a force element.

A pulling chain (10) embedded in the toothed wheel (7) generates torque to loosen the nut (24) when pulled by the hydraulic cylinder (6).

Preferably, the toothed wheel (7) is made of a lightweight material, preferably an aluminum-based alloy, such as aluminum 7075, and has a socket (8) in the center for a nut wrench (9). The socket (8) at the center is made of a heavy material, preferably a steel alloy, as it needs to be stronger than aluminum. The design allows for the replacement of the nut wrench for the corresponding size of each IPU (1) model.

A safety lock (22) on the toothed wheel (7) prevents the chain (10) from coming off.

Essentially, the pneumatic striker (3) is composed of a body (11), a striking piston or plunger (12), and a firing valve (15).

The body (11) of the pneumatic striker (3) is secured to the bolt (20) using an adapter nut (21), and the nut (21) is removable, allowing adjustment to different bolt models. Perforations (26) in the adapter nut (21) allow air to escape, preventing the dampening of impact.

The piston (12) is actuated with compressed air through a hose, preferably a 1¼″ hose, connected to the power source (4). The pressure is elevated between 300 psi and 350 psi to drive the striking piston (12) against the bolt (20).

The piston (12) returns automatically through a spring between the rear cap (13) of the body (11) and the piston (12). A normally open check valve (14) allows the evacuation of accumulated air inside the cylindrical body (11) of the pneumatic striker (3), facilitating the return of the piston (12). While the cylindrical body (11) is pressurized, the valve (14) prevents the escape of air.

The body (11) of the pneumatic striker (3) has a built-in quick-firing valve (15), which allows remote firing from a safe zone. The valve (15) is pneumatically piloted by taking pressure through a hose, preferably a ¼″ hose, from the power source (4).

Preferably, the final dimensions of the pneumatic striker (3) are approximately 327 mm in length with a larger diameter of approximately 194 mm, making it a compact device suitable for operation in confined spaces.

To unfasten the bolt (20), one or more shots are fired, and the air pressure is obtained from the power source (4). A compressor (16) supplies pressurized air at approximately 7 bar to a booster tank (18). The tank (18) acts as an accumulator for the air volume required for the strike. Initially, the tank (18) is filled with approximately 20 liters of air at a pressure of approximately 7 bar supplied by the compressor (16). Then, with the hydraulic pump (17), the air pressure is increased to approximately 21 bar. Inside the booster tank (18), a piston (not shown) separates the pneumatic circuit from the hydraulic one. The hydraulic pressure is transferred to the pneumatic circuit with the piston.

The sequence and pressure control are carried out by a PLC (Programmable Logic Controller). The control reads the state of switches and buttons and actuates the power relays of the hydraulic pump (17) and the air compressor (16).

The power source (4) is powered by a 12 V direct current from an external supply, such as the battery of a running truck or vehicle.

In particular, the hydromechanical key (2) includes a fixing anchor (5) as a fixed point of pull. The fixing anchor (5) is connected to a double-acting hydraulic cylinder (6) as a force element. A cable wheel (7) has a socket (8) for a wrench (9) in the center, and a pull chain (10) engages in the cable wheel (7) during use to generate torque for loosening a nut (24) when pulled by the hydraulic cylinder (6).

Also particularly, the pneumatic striker (3) includes a body (11), a striking piston or plunger (12) movably mounted inside it with a spring (not shown) located between the back cover (13) of the body (11) and the plunger (12), a normally open check valve (14), and a firing valve (15) integrated into the body (11). In use, the body (11) of the pneumatic striker (3) is attached to a bolt (20) of an IPU (1) by means of an adapter nut (21) that is removable, allowing adjustment to different types of bolts (20). The adapter nut (21) includes perforations (26) that release air to prevent dampening the impact. The body (11) has an integrated rapid-firing valve (15), which allows remote firing of the plunger (12) from a safe area. The return of the plunger (12) is automatically performed by the spring and the normally open check valve (14), which allows the evacuation of accumulated air within the cylindrical body (11) of the striker (3), and while the cylindrical body (11) is pressurized, the valve (14) prevents the escape of air. The firing valve (15) is pneumatically piloted, taking pressure through a hose from the power source (4).

Especially, the power source (4) includes an air compressor (16) and a hydraulic pump (17) connected to a booster tank (18) inside which there is a piston (not shown) that separates the pneumatic circuit from the hydraulic one. There is also an electrical/electronic circuit (19) that includes a PLC (Programmable Logic Controller) that controls sequences and pressures, governs switches and buttons on a control panel (26), and actuates power relays of the equipment. During use, the compressor (16) supplies pressurized air at approximately 7 bar to the tank (18), acting as an accumulator for the required air volume for each request. The hydraulic pump (17) increases the air pressure to approximately 21 bar, transferring hydraulic pressure to the pneumatic circuit with the piston.

In a preferred embodiment, the components of the power source (4) are mounted on a chassis (34) that has a tray (35) as a floor and is covered by a sheet metal cover (36). The hydraulic circuit uses oil as a fluid, which is available in a reservoir tank (37) connected to the hydraulic pump (17). A pressure switch (38) governs the balance between the hydraulic and pneumatic circuits based on the pressure recorded in the accumulator tank (18). The pressures of the hydraulic and pneumatic circuits are recorded by respective pressure gauges located on the control panel (33).”

It is another object of the present invention to provide a method for carrying out the stroke change of an individual pumping unit (IPU) (1) with the described equipment, which includes a hydromechanical key (2), a pneumatic striker (3), and a power source (4). The method comprises the following steps:

1) extracting the first nut (24) from the crank of an individual pumping unit (IPU) (1) using the hydromechanical key and loosening the second nut on the opposite side with the hydromechanical key installed on that side; and

2) unfastening a first bolt (20) by screwing a locknut (30) onto said bolt (20) to be unfastened, placing a threaded cap (31) on the bolt (20), screwing an adapter nut (21), and aligning the cylindrical body (11) of the pneumatic striker (3) correctly; then repeating the maneuver to unfasten the second bolt (20).

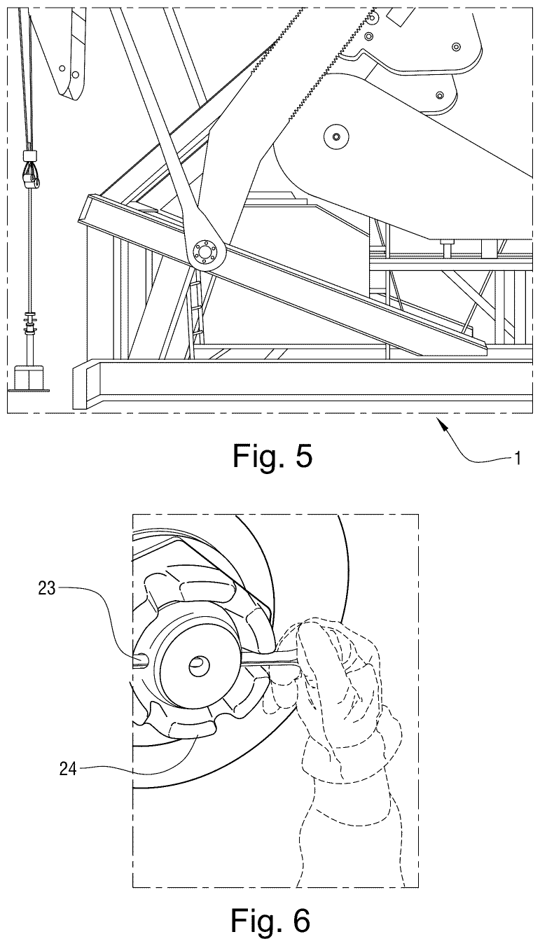

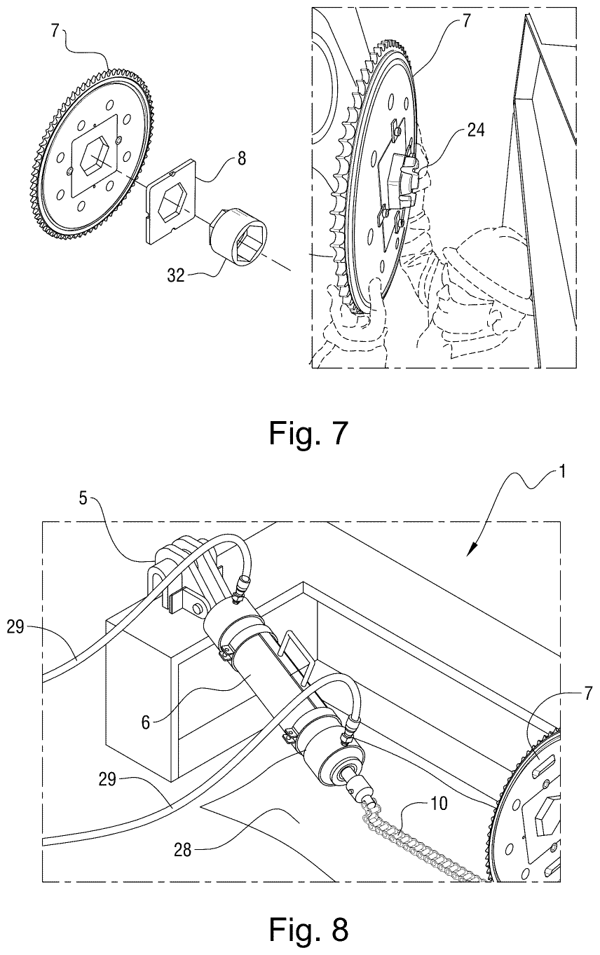

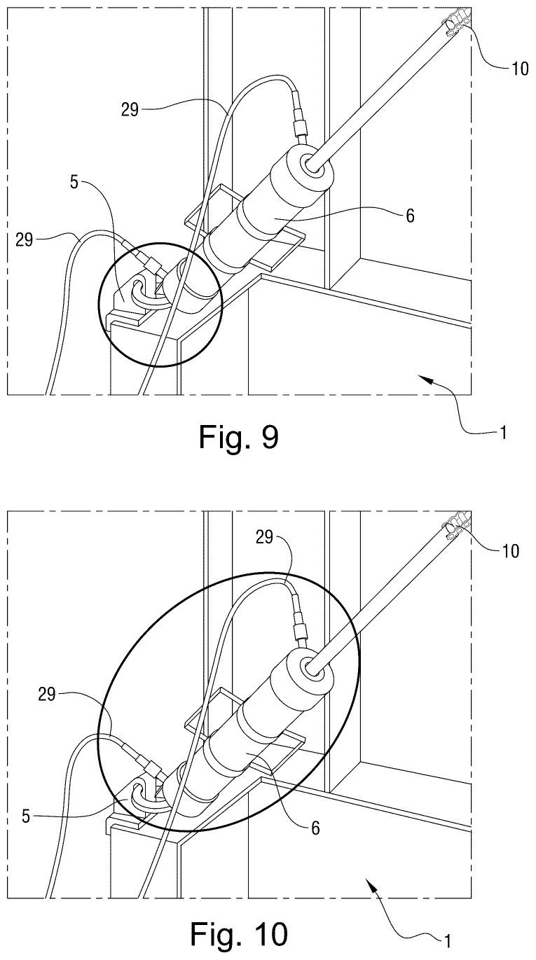

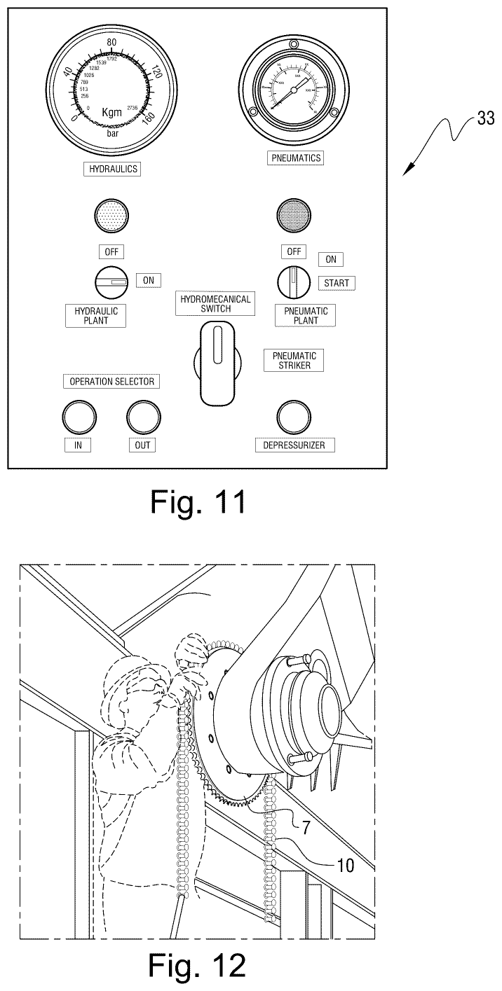

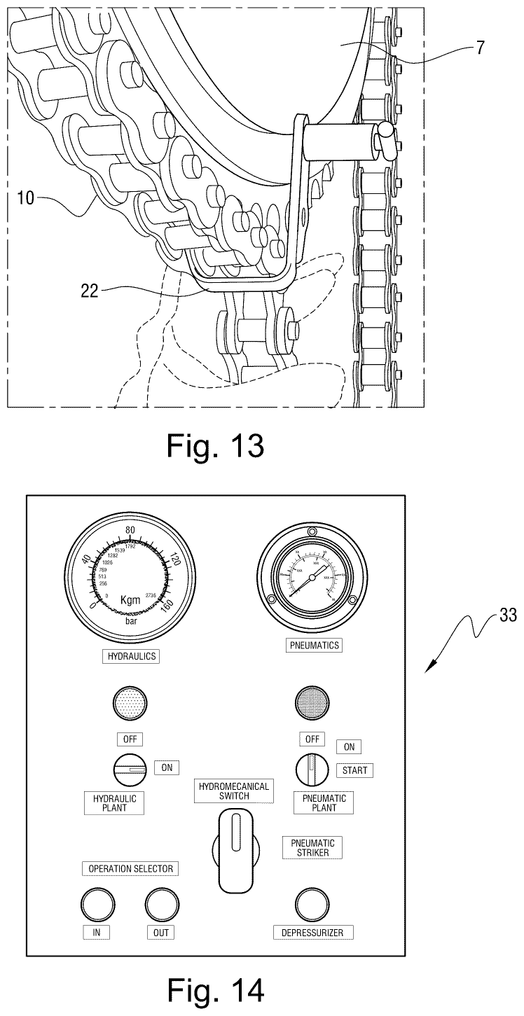

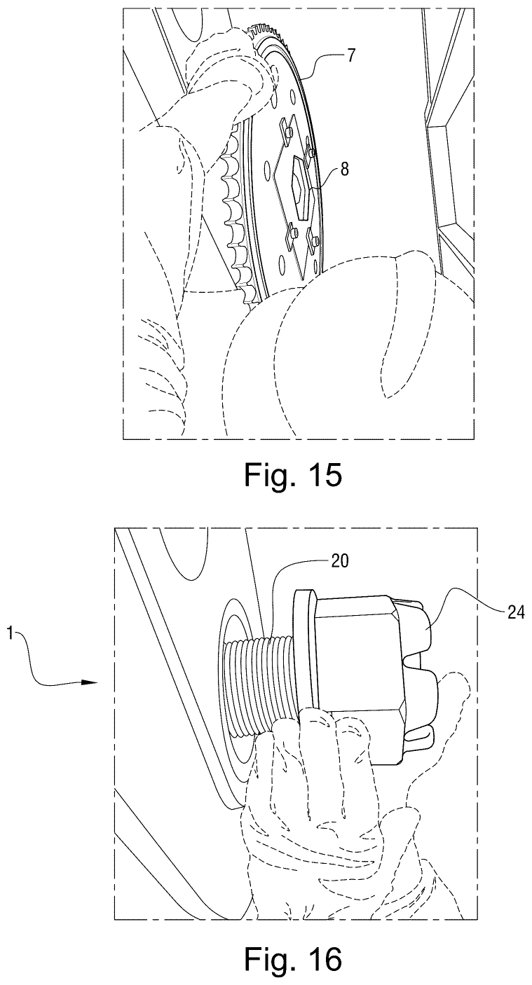

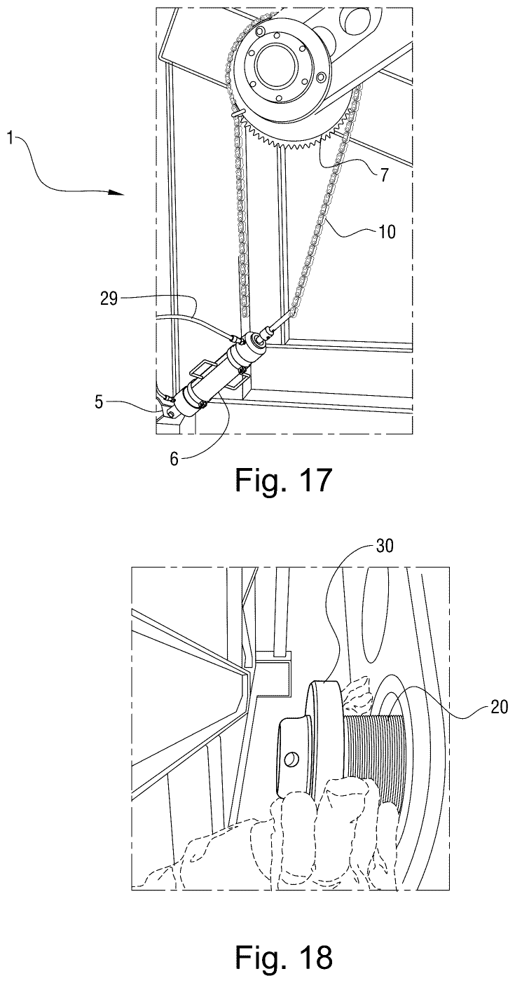

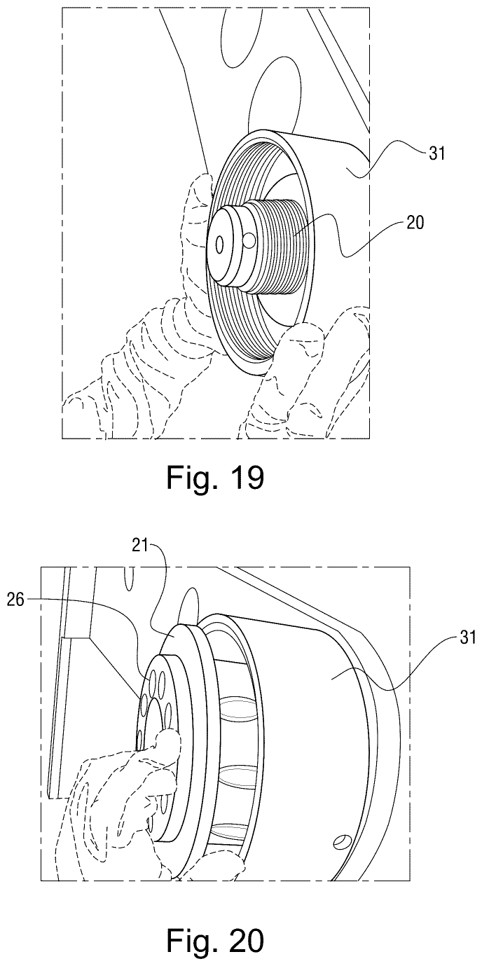

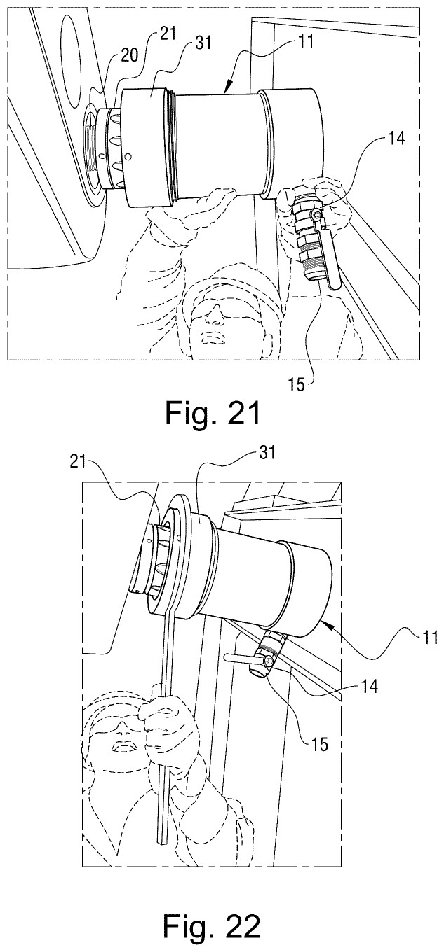

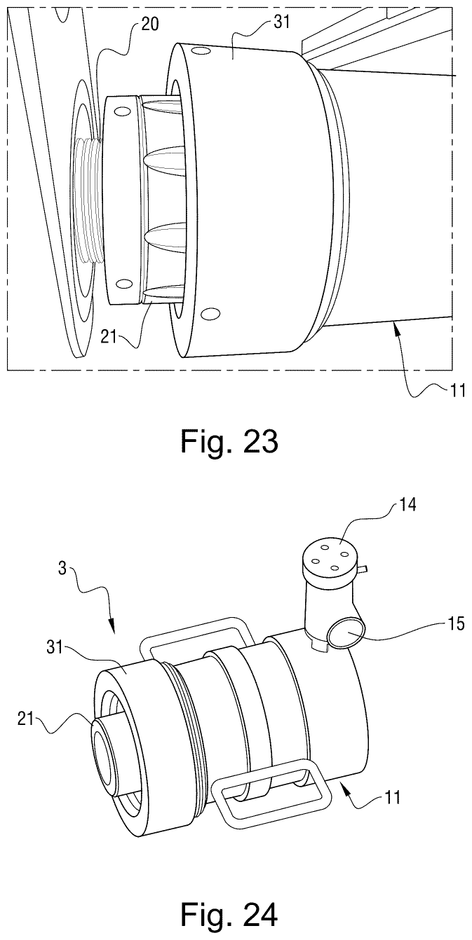

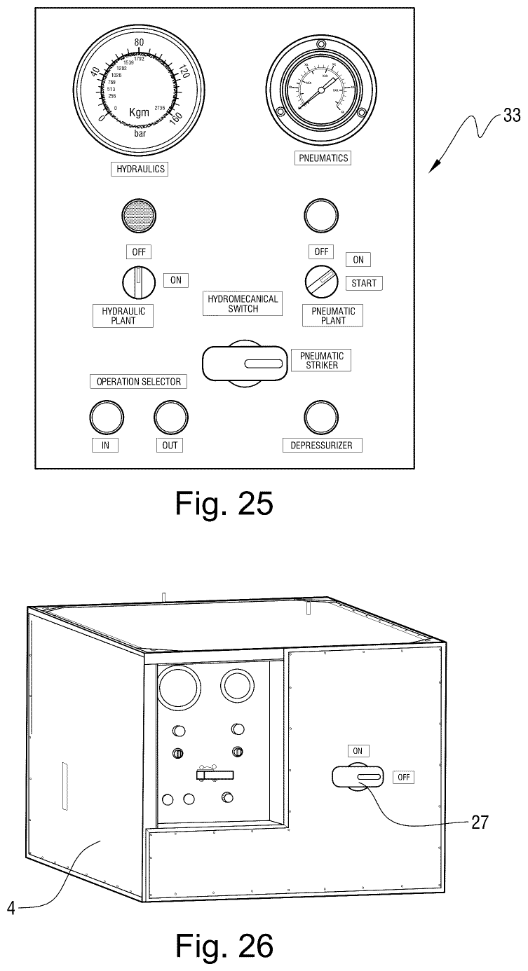

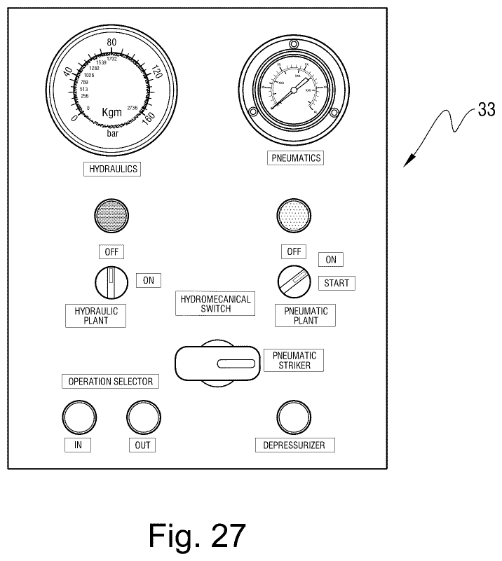

Thus, the procedure involves carrying out the following steps and sub steps:
1) Nut Extraction (24):
a) Position the crank of an individual pumping unit (IPU) (1) so that the pneumatic striker (3) can be installed (see FIG. 5).
b) Remove the key cotter pin (23) from the nut (24) (see FIG. 6).
c) Place the toothed wheel (7), ensuring that the interchangeable center fitment (8) of the toothed wheel (7) is the correct one. The toothed wheel (7) uses a core with a hexagonal or square fitment (8) according to the specific size of each IPU (1) model and brand. Select the suitable center and/or tube (32) according to the size of the nut (24) and the corresponding fitment (8) (see FIG. 7).
d) Place a cover (28) under the working area of the tools to prevent the chain (10) from getting dirty.
e) To use the hydromechanical key (2), the hydraulic cylinder (6) must be hooked onto the double “T” profile at the front of the IPU (1) chassis (see circle in FIG. 9) For some brands and/or models of IPU (1), an anchor adapter must be used for the hydraulic cylinder (6).
f) Connect the two oil hoses (29) from the power source (4) to the hydraulic cylinder (6) (see circle in FIG. 10). Check and ensure that the couplings are correctly connected.
g) Verify that the electrical power installation is correct.
h) Check the oil level by observing the level in the power source (4), particularly on the left side of the source (4). The level should be completely covered or full when operating the hydraulic cylinder (6); otherwise, the hydraulic pump (17) will work with low fluid level, causing the cylinder (6) to malfunction and/or damaging the pump (17).
i) Place the “Operation Selector” valve located on the control panel (26) of the power source (4) in the “Hydromechanical Key” position (see FIG. 11).
j) Power the hydraulic pump by turning the “Hydraulic Power Plant” key to the “ON” position.
k) Press the “OUT” button until the entire rod of the hydraulic cylinder (6) is fully extended.
l) Place the pulling chain (10) over the toothed wheel (7) in a way that it wraps at least half a turn of the wheel (7), considering the direction of rotation, and make sure it is tensioned (see FIG. 12).
m) Secure the free end of the chain (10) or its last link to the wheel with a safety pin (22) (see FIG. 13).
n) Move away from the work area; it is recommended to stand behind the person operating the equipment while it is running.
ñ) Press the “IN” button until the nut (24) loosens (see FIG. 14). Normally, this happens as soon as the rod of the hydraulic cylinder (6) retracts by 10 to 15% of its length, i.e., approximately between 3 and 5 cm, from when the chain (10) is tensioned. De-energize the hydraulic pump (17) by turning the “Hydraulic Power Plant” key to the “OFF” position.
o) Remove the safety pin (22) from the chain (10) and take it off the toothed wheel (7). Place the chain (10) on the protective cover (28). It is crucial to keep the chain (10) clean (see FIG. 15). Remove the nut (24) (see FIG. 16).
p) To loosen the nut (24) on the other side, repeat all the steps of this operation except steps 1.a), 1.g), 1.h), and 1.i). Consider the direction of rotation when placing the chain (10) on the toothed wheel (7) (see FIG. 17).
q) Before disconnecting the hoses (29) from the hydraulic cylinder (6), retract the rod until it is fully inside, achieved by pressing the “IN” button on the control panel (26) of the power source (4).
r) Install protectors corresponding to the connection points of the cylinder (6) and hoses (29).
2) Unclamping of Bolts (20):
Once both nuts (24) have been removed from the IPU (1), you are ready to start the process of unclamping the bolts (20).
a) First, the threads of the bolts (20) must be thoroughly cleaned with a steel brush. Then proceed to install the pneumatic striker (3) as follows:
b) Screw a locknut (30) onto the bolt (20) to be unclamped (see FIG. 18).
c) Place a threaded cap (31) on the bolt (20) (see FIG. 19). This threaded cap (31) remains freely supported on the bolt.
d) Screw on an adapter nut (21) (see FIG. 20). The nut (21) should be screwed until it comes into contact with the recess of the bolt (20). Ensure that the tip of the bolt (20) protrudes from the front of the nut (21).
e) Support the cylindrical body (11) of the pneumatic striker (3) in such a way that the recess of the nut (21) fits into it, to achieve correct alignment (see FIG. 21).
f) Screw on the cap (31) and tighten it against the cylindrical body (11) of the pneumatic striker (3) (see FIG. 22). To do this, an appropriate wrench must be used.
g) Tighten the locknut (30) against the nut (21) of the pneumatic striker (3). This way, the cylindrical body (11) is firmly fixed to the bolt (20) to be unclamped (see FIG. 23).
h) The position of the trigger valve (15) must be carefully considered before the final adjustment of the pneumatic striker (3). If necessary, rotate the striker (3), which should not be done from the valve (15). The cap must be loosened, the striker (3) adjusted, and then tightened again.
i) Connect the end of a 1¼″ hose to the quick-trigger valve (15) located on the pneumatic striker (3) (see FIG. 24). An appropriate wrench should be used for this task.
j) Connect a ¼″ hose to the quick-trigger valve (15) using the quick coupling. This way, the system will be ready to start the air compression.
k) Position the “Operation Selector” valve located on the control panel (26) of the power source (4) to “Pneumatic Striker” (see FIG. 25).
1) Verify that the vehicle providing the driving force is accelerated to a minimum of approximately 1,500 rpm, and that the electrical connections are secure.
m) Power up the air compressor by turning the “Pneumatic Power Plant” key to the “ON” position (see FIG. 25).
n) To start the compression process, turn the “Pneumatic Power Plant” key to the “Start” position (see FIG. 25), where this key will automatically return to the “ON” position. Then, it should remain in the “ON” state. The system will automatically raise the pneumatic pressure to approximately 21 kg/cm2. Under normal conditions, the “Hydraulic” pressure gauge should never exceed approximately 23 kg/cm2 for this operation (see FIG. 25).
o) After a few moments of initiating the compression process, check for leaks or losses. Depressurize the system by pressing the “Depressurized” button (see FIG. 25) and slowly opening the trigger valve (27) (see FIG. 26) until total depressurization of the system is confirmed. Then, check/inspect the condition and correct connection of the hoses, and if a loss is found due to an incorrect connection, connect it correctly, check the condition of the other connections, and restart the process from sub-step 2.c).
p) Once the power source (4) raises the air pressure to approximately 21 kg/cm2 and stops, the power source (4) should be de-energized. To do this, turn the “Pneumatic Power Plant” key to the “OFF” position (see FIG. 25). This way, the system is safely prepared to actuate the trigger valve (15).
q) Clear the work area, positioning yourself behind the STAIB equipment operator.
r) To release the bolt (20), rapidly open the “Trigger Valve” (27) located at the front of the power source (4) (see FIG. 26), moving it to the “ON” position. Once the shot is fired, the “Trigger Valve” (27) should be returned to the “OFF” position. If the “Trigger Valve” (27) quickly returns to the “OFF” position, there will be sufficient pressure, i.e., greater than approximately 9 kg/cm2, to perform another shot without having to repeat the pressurization sequence. If the bolt (20) is not released with the first shot, a new shot is performed. To do this, repeat the previous step if the pressure is greater than approximately 9 kg/cm2 according to the air pressure gauge, or from step 2.n) of pressurization if the pressure is very low, i.e., less than approximately 9 kg/cm2, as many times as necessary. Keep in mind that to achieve a good impact at the time of firing, the pressure indicated on the “Pneumatic” pressure gauge should not be less than approximately 9 kg/cm2, and at least approximately 20 seconds should be waited between shots.
s) Once the bolt (20) is released, the pneumatic line should be depressurized by pressing the “Depressurize” button located on the control panel (26) of the power source (4) (see FIG. 27). Keep the button pressed until the pressure indicated on the “Pneumatic” pressure gauge stops decreasing.
t) Slowly move the trigger valve (15) to the “ON” position and leave it open. Wait until the pressure indicated on the “Pneumatic” pressure gauge reads “zero” (0). Otherwise, attempting to disconnect the hose (1¼″ or ¼″) may cause it to eject, potentially injuring the operator. Return the trigger valve (15) key to the “OFF” position.
u) Unscrew the 1¼″ hose from the trigger valve (15) of the pneumatic striker (3).
v) Disconnect the ¼″ hose from the trigger valve (15) of the pneumatic striker (3).
w) Unscrew the cap (31) from the cylindrical body (11) of the pneumatic striker (3) and disassemble the cylindrical body (11).
x) Repeat all the previously indicated steps from 2.b) to release the other bolt (20).

To recompress in the middle of a bolt (20) unlocking operation, in cases where the bolt (20) did not release with the first shot and the air pressure indicated on the pressure gauge is less than approximately 9 kg/cm2, you should lower the pneumatic pressure below approximately 3 kg/cm2. Otherwise, the air compressor (16) will not start. To do this:

i) Keep the “Depressurize” button on the control panel (26) of the power source (4) pressed (see FIG. 27) until the “Pneumatic” pressure gauge indicates a pressure lower than approximately 3 kg/cm2.

ii) If it's not possible to lower the pressure enough, very slowly move the trigger valve (15) to “ON” to open the trigger valve (15) of the pneumatic striker (3) located on the front of the power source (4).

Once the pressure is below approximately 3 kg/cm2, return the trigger valve (15) of the pneumatic striker (3) to the “OFF” position.

Then, move the Hydraulic Power Plant key located on the control panel (26) of the power source (4) to the “Start” position (see FIG. 25). This way, the system will automatically raise the pneumatic pressure to approximately 21 kg/cm2. To continue with the bolt (20) unlocking, resume from step 1.p).

1. An apparatus for changing the stroke of an individual pumping unit comprising:
a hydromechanical wrench;
a pneumatic striker; and
a power source;
the hydromechanical wrench comprising a fixing anchor attached to a double-acting hydraulic cylinder, a toothed wheel with a central socket for a wrench, and a pull chain;
the pneumatic striker comprising a body, a striking piston movably mounted inside with a spring located between the rear cover of the body and the piston, a normally open check valve, and a trigger valve integrated into the body;
wherein the check valve is pneumatically piloted by pressure from the power source; and
the power source comprising an air compressor and a hydraulic pump connected to an accumulator tank inside which a piston separates a pneumatic circuit from a hydraulic circuit, and an electrical/electronic circuit comprising a programmable logic controller;
wherein the programmable logic controller controls sequences and pressures, governs switches and buttons, and actuates power relays of the equipment from a control panel.

2. The apparatus of claim 1,
the fixing anchor acting as a fixed point of pull;
the double-acting hydraulic cylinder attached to the anchor as a force element; and
the pull chain engaged with the toothed wheel to generate torque for loosening a nut when pulled by the hydraulic cylinder.

3. The apparatus of claim 1,
further comprising a bolt, and
the body of the pneumatic striker fixed to the bolt by means of a removable adapter nut that includes perforations that allow air to escape; and
the trigger valve comprising a quick-release trigger valve that allows remote triggering of the piston from a safe zone.

4. The apparatus of claim 1,
the compressor configured to supply pressurized air to the pneumatic circuit of the tank at approximately 7 bar; and
the hydraulic pump configured to supply force to the piston to increase the air pressure of the pressurized air to approximately 21 bar.

5. The apparatus of claim 1, wherein the toothed wheel is made of a lightweight material, preferably an aluminum alloy, more preferably aluminum 7075.

6. The apparatus of claim 1, wherein the center fitting on the toothed wheel is made of heavy material.

7. The apparatus of claim 1, the toothed wheel comprising a safety feature to prevent the chain from coming loose.

8. The apparatus of claim 1, the pneumatic circuit comprising a compressed air hose connected from the power source to the striking piston.

9. The apparatus of claim 8, further comprising a bolt fixed to the pneumatic striker;
the pneumatic circuit comprising pressurized air at a pressure between 300 psi and 350 psi; and
the pressurized air acting to drive the striking piston against the bolt.

10. The apparatus of claim 1, wherein the final dimensions of the striker are approximately 327 mm in length with a larger diameter of approximately 194 mm.

11. The apparatus of claim 1, wherein the programmable logic controller controls sequences and pressures by reading the state of switches and buttons and actuates the power relays of the hydraulic pump and the air compressor.

12. The apparatus of claim 1, the external power supply comprising a vehicle battery.

13. A method of performing a stroke change of an individual pumping unit (IPU) with the equipment described in claim 1, comprising the steps of:
1) removing a first nut from the handle of an IPU with the hydromechanical wrench, and loosening a second nut on the other side with said hydromechanical wrench installed on the opposite side; and
2) unbolting a first bolt by screwing the locknut onto said bolt to be unfastened, placing the threaded cap on the bolt, screwing the adapter disc, and supporting the pneumatic striker cylinder correctly aligned; then repeating the maneuver to unfasten the second bolt.

14. The method of claim 13, where the removing of the nuts in step 1 comprises the following sub-steps:
a) positioning the handle of the IPU so that the pneumatic striker can be installed;
b) removing a key stock from the nut;
c) placing a cable wheel comprising an interchangeable center, and ensuring that the interchangeable center of the cable wheel is correct;
d) engaging the hydraulic cylinder on a double “T” profile at a front of the IPU chassis to use the hydromechanical wrench;
e) placing the “Operation Selector” valve on the power source's control panel in a “Hydromechanical Wrench” position;
f) pressing an “OUT” button until the entire hydraulic cylinder rod is fully extended;
g) placing the chain over the cable wheel in such a way that it embraces at least half a turn of the wheel, considering the direction of rotation and ensuring it remains under tension;
h) securing the chain to the wheel with a safety feature on the free end of the chain or its last link;
i) pressing an “IN” button until the nut loosens and de-energizing the hydraulic pump by turning the “Hydraulic Power Plant” key to an “OFF” position;
j) removing the chain's safety feature, taking it off the cable wheel, placing the chain on the protective cover, and removing the nut;
k) loosening the second nut on the other side by repeating all stages of this operation except steps a) and e);
l) retracting the rod until it is fully inside by pressing the “IN” button on the power source's control panel before disconnecting the hoses from the hydraulic cylinder.

15. The method of claim 14, where, in step c), the appropriate center and/or tube must be selected based on the nut size and the corresponding socket, where the core of the cable wheel uses a core with a hexagonal or square socket, according to the specific size of each brand and/or model of the IPU.

16. The method of claim 14, where, in step d), an anchoring adapter for the hydraulic cylinder must be used according to the brand and/or model of the IPU.

17. The method of claim 14, where, in step i), the nut is loosened as soon as the rod retracts by approximately 10% or 15% of its length from when the chain is tensioned.

18. The method of claim 14, where, in step j), the direction of rotation is taken into account when placing the chain on the cable wheel.

19. The method of claim 13, where the unbolting and extraction of the bolts in step 2 comprise the following sub-steps:
a) cleaning bolt threads of the bolt thoroughly with a steel brush;
b) screwing the locknut onto the bolt to be unfastened;
c) placing the threaded cap on the bolt, wherein the threaded cap remains freely supported on the bolt;
d) thread the adapter disc until it reaches a stop and a groove of the bolt and a front of the nut protrudes from a tip of the bolt;
e) support the pneumatic striker's cylinder (11) to properly align a recess of the nut (21) fits into the cylinder;
f) screw on the cap (31) and tighten it against the cylindrical body (11) of the pneumatic striker (3);
g) tighten the locknut (30) against the nut (21) of the pneumatic striker (3) to secure the cylindrical body (11) onto the bolt (20);
h) verify the position of the trigger valve (15) before the final adjustment of the pneumatic striker, and if the trigger valve is not in the correct position, loosen the cap, align the striker (3), and tighten it again;
i) connect the end of a 1¼″ hose to the quick-release trigger valve (15) located on the pneumatic striker (3);
j) connect a ¼″ hose to the trigger valve (15) using a quick coupler;
k) position an “Operation Selector” valve located on the power source (4) control panel to “Pneumatic Striker”;
l) ensure that the vehicle providing the driving force is accelerated to a minimum of approximately 1,500 rpm and that electrical connections are secure;
m) energize the air compressor by turning a “Pneumatic Power Plant” key to an “ON” position;
n) to initiate the compression process, move the “Pneumatic Power Plant” key to a “Start” position, permitting the key to automatically return to the “ON” position and remain in that state, automatically raising the pneumatic pressure to approximately 21 kg/cm2;
o) after a few moments of starting the compression process, check for leaks or losses, and depressurize the system by pressing a “Depressurized” button, and slowly opening the trigger valve (27) until complete depressurization is confirmed, and then inspect the condition and proper connection of the hoses;
p) once the power source (4) raises the air pressure to approximately 21 kg/cm2 and stops, de-energize the power source by turning the “Pneumatic Power Plant” key to the “OFF” position to ensure that the system is safely prepared to actuate the trigger valve (15);
q) clear the work area, by being behind the operator of the IPU equipment;
r) unfasten the bolt (20), by rapidly opening a “Trigger Valve” switch (27) located on the front of the power source (4) to the “ON” position and then permitting the “Trigger Valve” switch (27) to return to the “OFF” position, and then repeating the rapidly opening step if the pressure is greater than approximately 9 kg/cm2 according to the air pressure gauge, first repeating step n) if the pressure is less than approximately 9 kg/cm2;
s) once the bolt (20) is unfastened, depressurize the pneumatic line by pressing the “Depressurized” button located on the power source (4) control panel until the pressure indicated on a “Pneumatic” gauge stops decreasing;
t) slowly move the trigger valve (15) to the “ON” position and leave it open until the pressure indicated on the “Pneumatic” gauge is zero, then return the trigger valve (15) key to the “OFF” position;
u) unscrew the 1¼″ hose from the trigger valve (15) on the pneumatic striker (3);
v) disconnect the ¼″ hose from the trigger valve (15) on the pneumatic striker (3);
w) unscrew the cap (31) from the cylindrical body (11) of the pneumatic striker (3) and disassemble the cylindrical body (11); and
x) repeat all the aforementioned steps from b) to unfasten the other bolt (20).

20. The method of claim 19, wherein, in step h), if it is necessary to align the pneumatic striker, turn it by loosening the cover, adjusting the striker, and then tightening it again.

21. The method of claim 19, wherein, in step n), automatically raising the pneumatic pressure to approximately 21 kg/cm2 but not above approximately 23 kg/cm2.

22. The method of claim 19, wherein, in step n), if there are leaks or losses, depressurizing the system by pressing the ‘Depressurize’ button and slowly opening the trigger valve until verifying the total depressurization of the system, and after fixing the leak or loss, restart the process from sub-step e).

23. The method of claim 19, wherein, in step q), to recompress in the middle of a bolt unfastening operation if the bolt did not unfasten with the first shot and the air pressure indicated on the pressure gauge is less than approximately 9 kg/cm2, the lowering the pneumatic pressure to below approximately 3 kg/cm2 to permit the air compressor to start, following these steps:
i) keeping the “Depressurized” button on the power source control panel pressed until the “Pneumatic” pressure gauge indicates a pressure lower than approximately 3 kg/cm2; and
ii) if it is not possible to lower the pressure enough, very slowly move to “ON” to open the trigger valve of the pneumatic striker located on the front of the power source;
iii) once the pressure is below approximately 3 kg/cm2, return the trigger valve of the pneumatic striker to the “OFF” position;
iv) then, move the “Hydraulic Power Plant” key located on the power source control panel to the “Start” position so that the system automatically raises the pneumatic pressure to approximately 21 kg/cm2; and
v) to continue with the bolt unfastening, return to step o).
